(19) United States
(12) Patent Application Publication
(10) Pub. No.: US 2023/0353405 A1
(43) Pub. Date: Nov. 2, 2023

(54) SELECTIVE MUTE OF VIDEO STREAMS IN VIDEO CONFERENCES

(71) Applicant: Avaya Management L.P., Durham, NC (US)

(72) Inventors: Hrishikesh Mahajan, Pune (IN); Mohan Phadnis, Pune (IN)

(21) Appl. No.: 17/731,079

(22) Filed: Apr. 27, 2022

(51) Int. Cl. H04L 12/18; H04N 7/15

(52) U.S. Cl. CPC H04L 12/1827; H04N 7/157

(57) ABSTRACT

Remote conferences often comprise audio and video feed signals originating from a number of participants' communication devices. A participant may disable a cameras or microphones but doing so affects every other participant equally. Embodiments provided herein are directed to enabling a participant to mute a video feed presented to some but not all participants of the conference. At the same time audio may be provided to every participant.

### FIELD OF THE DISCLOSURE

The invention relates generally to systems and methods for remote conferences and particularly to managing the video stream of the remote conference.

### BACKGROUND

During a video conference, in particular one with a large number of participants, some of the participants may want to provide their video image to only certain other participants but not all of the other participants. However, participants must either provide their video to every other participant or turn off their video and have it excluded from all other participants.

### SUMMARY

In the prior art, a participant in a conference either provides or omits their video feed (most commonly comprising a video image of themselves) entirely from the conference. A conference participant may manage their privacy by including or omitting their video, but such actions equally affect each participant of the conference. All participants are provided with the conference content, such as an aggregate image of all or at least a portion of the video feeds from each participant, and that either includes or excludes video from a particular participant. This all-or-none approach is often counterproductive when a user (or conference administrator) wants to provide video (e.g., live image of a conference participant) to some, but not all, participants of the conference. For example, during a video conference to discuss legal matters, a participant may wish to provide their video image to their legal counsel but not to an adversarial party. At the same time, they may be provided with video from all other participants, including those excluded from receiving the video image of the participant. In the prior art, two separate communication channels must be established to utilize separate communication devices, rights management, input/output components, etc., so that one channel can include video and a second channel can omit video. Or, more commonly, if video needs to be excluded from at least one other participant, the video is simply disabled and excluded for all participants. As a result, selectively providing a video feed to some but not all participants, each being a participant of the same conference, is not possible in the prior art.

These and other needs are addressed by the various embodiments and configurations of the present invention. The present invention can provide a number of advantages depending on the particular configuration. These and other advantages will be apparent from the disclosure of the invention(s) contained herein.

In one embodiment, participants in a video conference may provide audio and video to a conference server that provides a first and second conference stream. Each of the first and second conference streams comprise audio, but only one of the first or second conference streams provide video whereas the other omits the provided video.

In another embodiment, the participants in the video conference may provide audio and video to the conference server that provides a first and second conference stream. The first conference stream comprises the audio and video whereas the second conference stream comprises the audio and a redacted video image so as to not provide the video of particular participants to others not approved or disapproved.

In one embodiment, a method for managing a remote conference is disclosed, comprising: receiving signal from each of a number of communication devices wherein the signals comprising an audio stream and a video stream; generating a first conference stream comprising the signals from each of the number of communications devices; generating a second conference stream comprising the signals comprising the audio stream from each of the number of communications devices and excludes the video stream from at least one of the number of communication devices; broadcasting the first conference stream to a first subset of the number of communication devices wherein the first subset comprises at least one communication device; and broadcasting the second conference stream to a second subset of the number of communication devices wherein the first subset comprises at least one communication device; and wherein the first subset and the second subset are disjoint sets.

In another embodiment, a system for broadcasting a remote conference, comprising: a network interface to a network; a processor; and wherein the processor performs: receiving, via the network, signals from each of a number of communications devices wherein the signals comprising an audio stream and a video stream; generating a first conference stream comprising the signals from each of the number of communications devices; generating a second conference stream comprising the signals comprising the audio stream from each of the number of communications devices and signals comprising at least one but less than all video stream from the number of communication devices; broadcasting, via the network, the first conference stream to a first subset of conference devices wherein the first subset of conference devices comprises at least one conference device; and broadcasting, via the network, the second conference stream to a second subset of conference devices wherein the second subset of conference devices comprises at least one conference device.

In one embodiment, a system is disclosed, comprising: means to receive, via the network, signals from each of a number of communications devices wherein the signals comprising an audio stream and a video stream; means to generate a first conference stream comprising the signals from each of the number of communications devices; means to generate a second conference stream comprising the signals comprising the audio stream from each of the number of communications devices and signals comprising at least one but less than all video stream from the number of communication devices; means to broadcast, via the network, the first conference stream to a first subset of conference devices wherein the first subset of conference devices comprises at least one conference device; and means to broadcast, via the network, the second conference stream to a second subset of conference devices wherein the second subset of conference devices comprises at least one conference device.

A system on a chip (SoC) including any one or more of the above embodiments or features of the embodiments described herein.

One or more means for performing any one or more of the above embodiments or features of the embodiments described herein.

Any feature in combination with any one or more other feature.

Any one or more of the features disclosed herein.

Any one or more of the features as substantially disclosed herein.

Any one or more of the features as substantially disclosed herein in combination with any one or more other features as substantially disclosed herein.

Any one of the features/features/embodiments in combination with any one or more other features/embodiments.

Use of any one or more of the features or features as disclosed herein.

Any of the above embodiments or features, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Features of the present disclosure may take the form of an embodiment that is entirely hardware, an embodiment that is entirely software (including firmware, resident software, micro-code, etc.) or an embodiment combining software and hardware features that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some features of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual feature of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a system in accordance with embodiments of the present disclosure;

FIG. 3. depicts a process in accordance with embodiments of the present disclosure;

FIG. 4. depicts a data structure in accordance with embodiments of the present disclosure; and

FIG. 5. depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

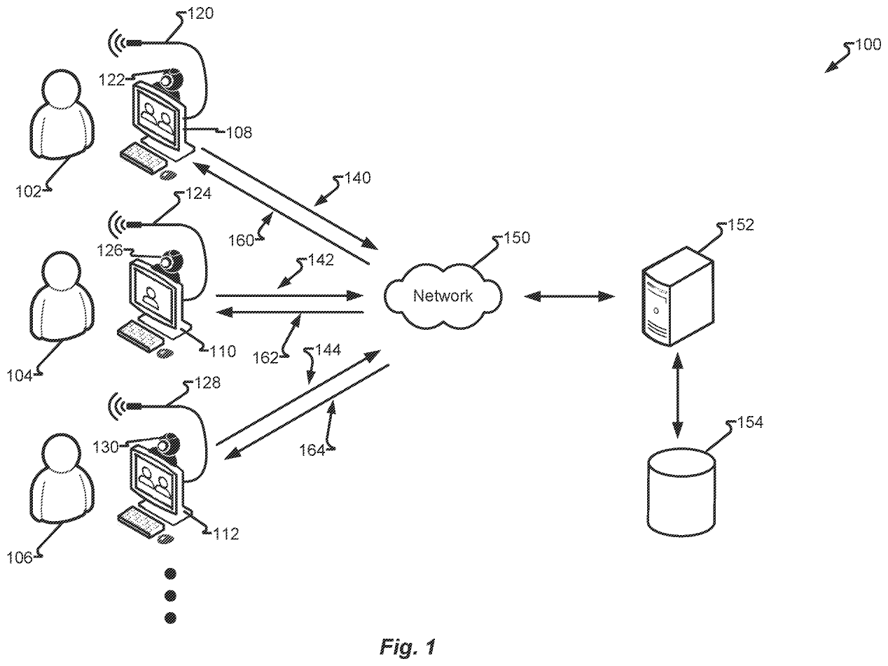

FIG. 1 depicts system 100 in accordance with embodiments of the present disclosure. In one embodiment, at least three participants (e.g., participant 102, participant 104, participant 106) are engaged in a conference comprising audio and video. The video and/or audio provided by any one participant may be selectively included or excluded from the conference content provided to server 152, such as by disabling or muting a camera or video used by the participant, which then causes server 152 to either have or not have such video or audio to include in the single stream of conference content provided to all other participants of the conference.

In another embodiment, in order to selectively include or exclude the provided video images from one participant, so as to be provided as the conference content to at least one but less than all other conference participants, server 152 provides two discrete conference streams. For example, communication device 108 captures images of participant 102 with camera 122 and audio, such as comprising speech from participant 102, is captured by microphone 120. Similarly, communication device 110 captures images of participant 104 with camera 126 and audio, such as comprising speech from participant 104, is captured by microphone 124, and communication device 112 captures images of participant 106 with camera 130 and audio, such as comprising speech from participant 106, is captured by microphone 128. Conference input signals 140 comprise encoded video for transmission on network 150. Conference input signals 140 may also include one or more of audio, documents, still images, or co-browsing signals. Similarly, conference input signals 142 comprises video signals and optionally other signals, as too does conference input signals 144.

Server 152, which comprises or accesses data storage 154 which may contain rules, instructions, data, etc., formats one or more of conference input signals 140, conference input signals 142, conference input signals 144 into at least two discrete conference streams wherein at least one stream is sent to one of communication device 108, communication device 110, or communication device 112 as conference content 160, conference content 162, or conference content 164, respectively. And the one other stream is sent to a different one of communication device 108, communication device 110, or communication device 112 as conference content 160, conference content 162, or conference content 164, respectively.

In one embodiment, participant 102, participant 104, and participant 106 are each participants in the video conference and their respective speech and video image of themselves are provided to network 150 via conference input signals 140, conference input signals 142, and conference input signals 144, respectively. Therefore, two but not all of conference content 160, conference content 162, and conference content 164 may comprise video images of the same conference content (e.g., comprising all video received from conference input signals 140, conference input signals 142, and conference input signals 144). Similarly, at least one but not all of conference content 160, conference content 162, and conference content 164 may omit video images provided by at least one participant (e.g., comprising video received from less than all of conference input signals 140, conference input signals 142, and conference input signals 144). Optionally, one's own video and/or audio signals may be omitted for themselves, such as to avoid audio feedback issues and/or distractions caused by seeing one's own image, especially when presented with a delay due to inherent speed limitations of data transmission. For example, communication device 108 may decode the conference content for presentation of images on a display thereof and play audio on a speaker (not shown) that omits audio and/or video signals that originate from microphone 120 and/or camera 122 connected or comprised by communication device 108.

Server 152, such as by accessing a record maintained in data storage 154, may determine that participant 106 is designated to receive the first conference stream (i.e., including all video) video and, accordingly, provides communication device 112 with conference content 164 encoded as the first conference stream. Server 152, may similarly determine that participant 104 is designated to receive the second conference stream (i.e., including all video except for the video image of participant 102) and, accordingly, generates and provides communication device 110 with conference content 162 encoded as the second conference stream.

In another embodiment, server 152 may utilize different processing resources to generate the first and second video streams, and the first and second video streams may become unsynchronized. Accordingly, synchronization may be applied, such as to delay the more advanced of the video streams for maintaining synchronization between the first and second video streams and/or the audio and video within any one or both of the first and second video streams.

It should be appreciated that three participants (participant 102, participant 104, and participant 106) are illustrated but that more participants and their respective communication devices are also contemplated. Additionally or alternatively, participants may be observers that receive audio and video but do not contribute any audio and/or video signals. Observers may be transient, wherein a participant becomes an observer by ceasing to provide any audio/video content to network 150 or vice versa, such as when an observer is granted audio and/or video rights to ask a question or otherwise contribute to the conference. Observers may similarly be designed to receive either the first conference stream or the second conference stream. However, no one communication device, whether that of a participant or of an observer, receives both the first and the second conference stream at the same time.

As a further embodiment, two or more participants may omit providing video to two or more blocked recipients (e.g., observers or participants) while providing audio and, at the same time, at least one, unblocked recipient receives the audio with video. The blocked recipients may be the same recipient for both the two or more participants or may be different recipients.

In another embodiment, server 152 may further comprise a recording server, transcription server, or translation server that is not a member of either the participants or recipients and does comprise one of the communication devices, but which may receive the first and/or second conference streams for processing and/or recording thereof.

In another embodiment, audio and video feed signals are provided to server 152 and the video portion is provided to every other participant device in the conference but with audio provided to at least one but not all of the other participants' devices.

Embodiments herein are generally directed to selective sharing a live video image of one participant in a conference with some, but not all, other participants of the conference. However, it should be appreciated that other images may be utilized without departing from the scope of the embodiments herein. For example, the image may be, in whole or in part, a document, presentation, screen share, still image, etc. As a result, one participant, such as participant 102 may, for example, share a still image with participant 106 but not participant 104.

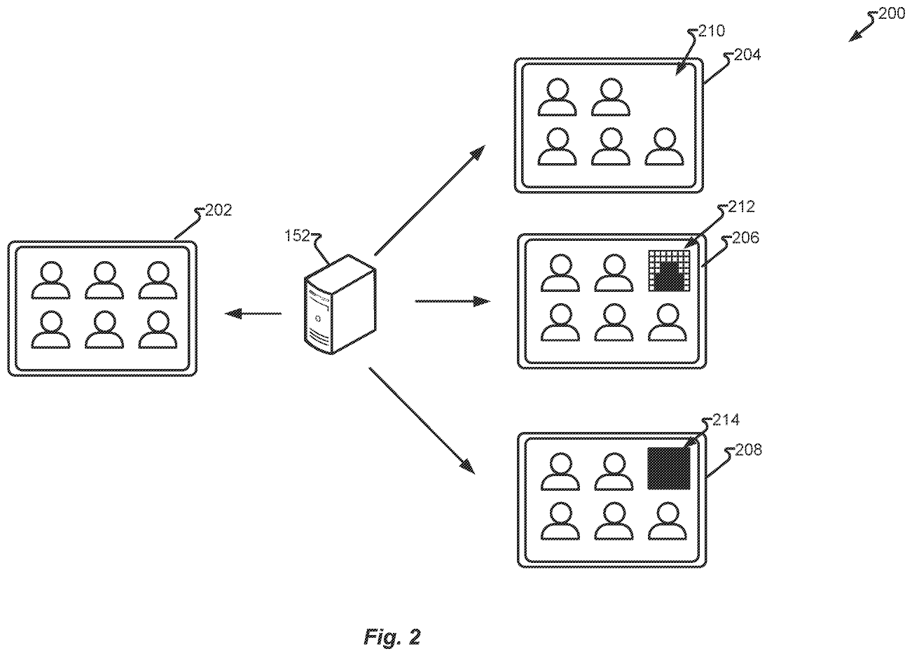

FIG. 2 depicts system 200 in accordance with embodiments of the present disclosure. In one embodiment, server 152 generates a first conference stream comprising encoded signals for audio and video, wherein the video signals include all received video signals received by server 152. For example, communication device 202 receives the first conference stream from server 152, illustrated as showing video images of six participants who are providing audio and video feed signals to server 152. Server 152 provides the second conference stream for delivery to a device, which may be embodied as communication device 204 displaying video image 210, wherein server 152 has provided the second video stream to communication device 204 which then displays five of the six video images of the participants. However, the audio portion would still include all audio feed signals received by server 152.

While video image 210 illustrates the second video stream wherein a block or omitted video signal is absent, in other embodiments an obscuring image is provided in place of the video image to be blocked. For example, communication device 206 receives the second video stream having pixelated image 212 to provide low resolution, such as to just make out a humanoid form. In another example, communication device 208 receives the second video stream having a blacked-out image in place of the video image to be blocked. Other obscurations may be utilized, such as a graphic of a text message (e.g., “video unavailable,” “video not approved for this participant,” etc.), a previously recorded video or still image (e.g., nature scene, logo, etc.), or a generated image (e.g., avatar, ceiling, floor, etc.). As a result, the second conference stream omits the blocked video image but, in its place, includes a replacement image or other image that is different from the blocked video image.

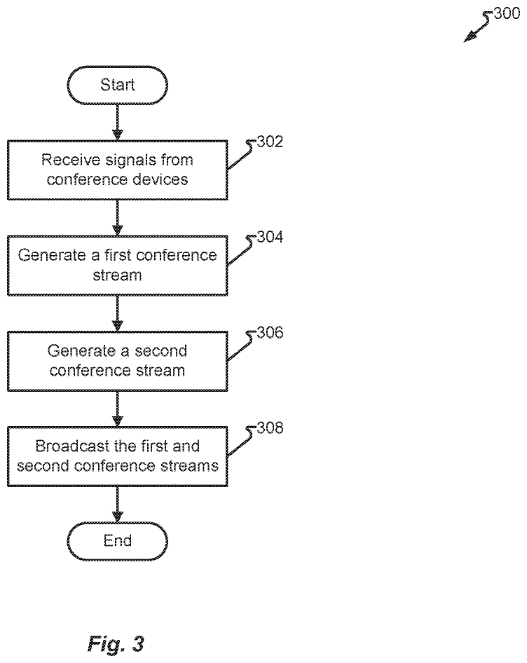

FIG. 3. depicts process 300 in accordance with embodiments of the present disclosure. In one embodiment, process 300 is embodied as machine-readable instructions maintained in non-transitory memory that, when read by a machine, such as a processor of server 152, cause the machine to perform the steps of process 300. Process 300 begins and step 302 receives signals from one or more communication devices, such as one or more of conference input signals 140, conference input signals 142, conference input signals 144, etc. The signals comprise both audio and video signals.

Step 304 generates a first conference stream comprising all audio and all video portions that are received by server 152 as feed from the conference input signals. Step 306 generates a second conference stream comprising all audio and all video received by server 152 except for at least one video portion of all the video portions received. Step 308 then broadcasts one of the first or the second conference streams to each participant and/or observer via their respective communication device.

It should be appreciated that process 300 illustrates one process but other arrangements are contemplated and may be utilized without departing from the scope of the disclosure. For example, steps 304 and 306 may occur in a different order or in parallel.

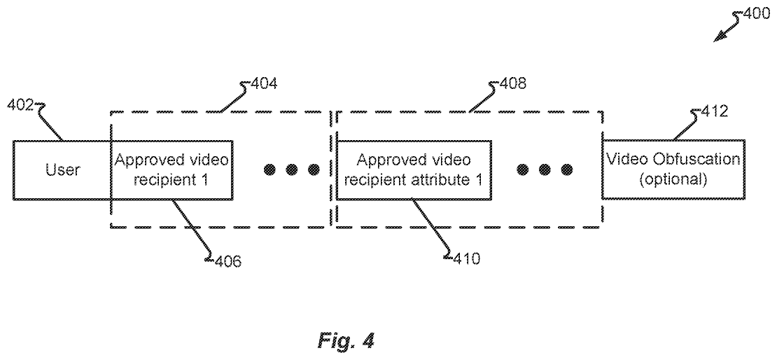

FIG. 4. depicts data structure 400 in accordance with embodiments of the present disclosure. In one embodiment, data structure 400 defines fields for one or more records of a database, such as may be maintained in data storage 154. User field 402 identifies a user (e.g., participant), such as by name, username, IP address for their respective communication device, or other identifier that uniquely identifies the user to server 152.

Data structure 400 may comprise one or more approved recipient block 404 which comprises an approved recipient identifier block 406 that similarly identifies recipients uniquely to server 152. In one embodiment, only recipients identified in block 404 receive the first conference stream comprising the video portion from the participant identified in user block 402.

Data structure 408 may comprise one or more approved recipient attribute block 410 which comprises an attribute that identifies a category of recipients to server 152. For example, recipient attribute block 410 may comprise a physical location attribute, domain attribute, address on a network, position, rank, role, etc., and any recipient having such an attribute receives the first conference stream comprising the video of the user identified in user block 402. For example, recipient attribute block 410 may identify a domain (e.g., “mycompany.com”) and any recipient utilizing or otherwise known to server 152 as having the domain receives the first conference stream. In contrast, a non-approved attribute, such as a different domain (e.g., “competitorcompany.com”) receives the second video stream that omits the video portion of the signals received from the user identified in recipient attribute block 410.

Data structure 400 is illustrated and described with respect to providing the second conference stream—a stream that omits a video image of at least one participant—to recipients (ones of user 402) except for recipients that match an identifier within block 404 and/or an attribute in block 408. Accordingly, those recipients not identified within block 404 and/or an attribute in block 408 receive the first conference stream and receive the video image. Accordingly, a recipient identified individually in a recipient identifier 406 within recipient identifier block 404 and/or identified as having an attribute matching recipient attribute 410 within a recipient attribute block 408, is provided with the video image in the first conference stream. Recipients not identified in record 400 are then provided with the second conference stream that omits the video image.

In another embodiment, one of ordinary skill will appreciate that data structure 400 may be modified so as to identify recipients who will receive the second conference stream, such as a modified recipient identifier block 406 or modified recipient attribute block 410. In such a modification, a recipient identified in modified record 400 is provided with the second conference stream that omits the video image. Recipients not identified in such a modified record are then provided with the first conference stream.

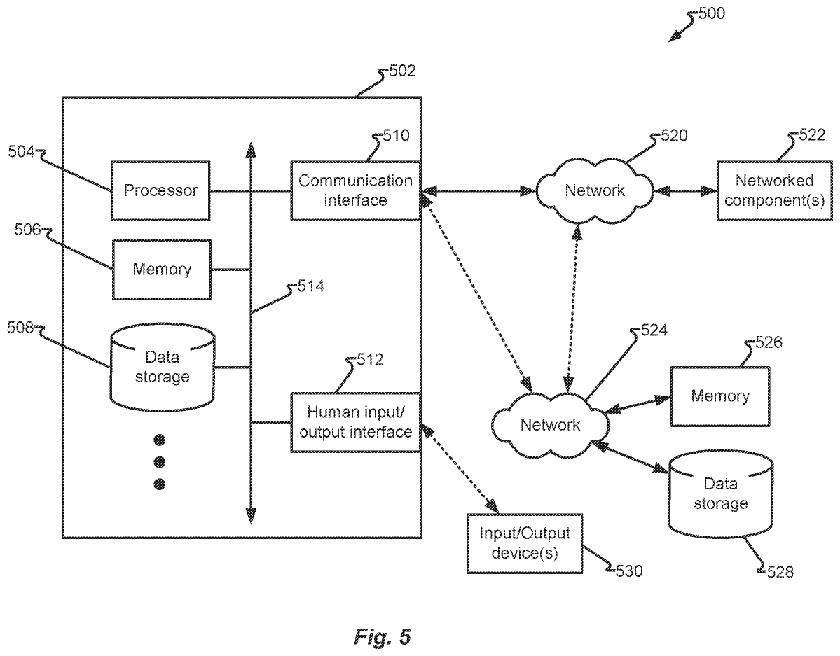

FIG. 5 depicts device 502 in system 500 in accordance with embodiments of the present disclosure. In one embodiment, server 152 may be embodied, in whole or in part, as device 502 comprising various components and connections to other components and/or systems. The components are variously embodied and may comprise processor 504. The term “processor,” as used herein, refers exclusively to electronic hardware components comprising electrical circuitry with connections (e.g., pin-outs) to convey encoded electrical signals to and from the electrical circuitry. Processor 504 may comprise programmable logic functionality, such as determined, at least in part, from accessing machine-readable instructions maintained in a non-transitory data storage, which may be embodied as circuitry, on-chip read-only memory, memory 506, data storage 508, etc., that cause the processor 504 to perform the steps of the instructions. Processor 504 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 514, executes instructions, and outputs data, again such as via bus 514. In other embodiments, processor 504 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 504 is a non-transitory computing device (e.g., electronic machine comprising circuitry and connections to communicate with other components and devices). Processor 504 may operate a virtual processor, such as to process machine instructions not native to the processor (e.g., translate the VAX operating system and VAX machine instruction code set into Intel® 9xx chipset code to enable VAX-specific applications to execute on a virtual VAX processor), however, as those of ordinary skill understand, such virtual processors are applications executed by hardware, more specifically, the underlying electrical circuitry and other hardware of the processor (e.g., processor 504). Processor 504 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 504, device 502 may utilize memory 506 and/or data storage 508 for the storage of accessible data, such as instructions, values, etc. Communication interface 510 facilitates communication with components, such as processor 504 via bus 514 with components not accessible via bus 514. Communication interface 510 may be embodied as a network port, card, cable, or other configured hardware device. Additionally or alternatively, human input/output interface 512 connects to one or more interface components to receive and/or present information (e.g., instructions, data, values, etc.) to and/or from a human and/or electronic device. Examples of input/output devices 530 that may be connected to input/output interface include, but are not limited to, keyboard, mouse, trackball, printers, displays, sensor, switch, relay, speaker, microphone, still and/or video camera, etc. In another embodiment, communication interface 510 may comprise, or be comprised by, human input/output interface 512. Communication interface 510 may be configured to communicate directly with a networked component or utilize one or more networks, such as network 520 and/or network 524.

Network 150 may be embodied, in whole or in part, as network 520. Network 520 may be a wired network (e.g., Ethernet), wireless (e.g., WiFi, Bluetooth, cellular, etc.) network, or combination thereof and enable device 502 to communicate with networked component(s) 522. In other embodiments, network 520 may be embodied, in whole or in part, as a telephony network (e.g., public switched telephone network (PSTN), private branch exchange (PBX), cellular telephony network, etc.)

Additionally or alternatively, one or more other networks may be utilized. For example, network 524 may represent a second network, which may facilitate communication with components utilized by device 502. For example, network 524 may be an internal network to a business entity or other organization, whereby components are trusted (or at least more so) that networked components 522, which may be connected to network 520 comprising a public network (e.g., Internet) that may not be as trusted.

Components attached to network 524 may include memory 526, data storage 528, input/output device(s) 530, and/or other components that may be accessible to processor 504. For example, memory 526 and/or data storage 528 may supplement or supplant memory 506 and/or data storage 508 entirely or for a particular task or purpose. As another example, memory 526 and/or data storage 528 may be an external data repository (e.g., server farm, array, “cloud,” etc.) and enable device 502, and/or other devices, to access data thereon. Similarly, input/output device(s) 530 may be accessed by processor 504 via human input/output interface 512 and/or via communication interface 510 either directly, via network 524, via network 520 alone (not shown), or via networks 524 and 520. Each of memory 506, data storage 508, memory 526, data storage 528 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 530 may be a router, switch, port, or other communication component such that a particular output of processor 504 enables (or disables) input/output device 530, which may be associated with network 520 and/or network 524, to allow (or disallow) communications between two or more nodes on network 520 and/or network 524. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various features of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and features, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and features, includes providing devices and processes in the absence of items not depicted and/or described herein or in various embodiments, configurations, or features hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or features for the purpose of streamlining the disclosure. The features of the embodiments, configurations, or features of the invention may be combined in alternate embodiments, configurations, or features other than those discussed above. This method of disclosure is not to be interpreted as reflecting an intention that the claimed invention requires more features than are expressly recited in each claim. Rather, as the following claims reflect, inventive features lie in less than all features of a single foregoing disclosed embodiment, configuration, or feature. Thus, the following claims are hereby incorporated into this Detailed Description, with each claim standing on its own as a separate preferred embodiment of the invention.

Moreover, though the description of the invention has included description of one or more embodiments, configurations, or features and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or features to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method for managing a remote conference, comprising:
receiving signal from each of a number of communication devices wherein the signals comprising an audio stream and a video stream;
generating a first conference stream comprising the signals from each of the number of communications devices;
generating a second conference stream comprising the signals comprising the audio stream from each of the number of communications devices and excludes the video stream from at least one of the number of communication devices;
broadcasting the first conference stream to a first subset of the number of communication devices wherein the first subset comprises at least one communication device; and
broadcasting the second conference stream to a second subset of the number of communication devices wherein the first subset comprises at least one communication device; and
wherein the first subset and the second subset are disjoint sets.

2. The method of claim 1, wherein excluding the video stream from the at least one of the number of communication devices comprises replacing the video stream with a replacement image.

3. The method of claim 2, wherein the replacement image comprises a previously obtained still image.

4. The method of claim 2, wherein the replacement image comprises a previously obtained video image.

5. The method of claim 2, wherein the replacement image comprises an avatar image.

6. The method of claim 1, wherein the first conference stream and the second conference stream are each broadcast concurrently.

7. The method of claim 6, wherein broadcasting the first conference stream and the second conference stream comprises inserting a delay into the broadcasting of one of the first conference stream or the second conference stream to synchronize the first conference stream and the second conference stream together.

8. The method of claim 1, further comprising broadcasting one or more of the first conference stream or the second conference stream to a recording server.

9. A system for broadcasting a remote conference, comprising:
a network interface to a network;
a processor; and
wherein the processor performs:
receiving, via the network, signals from each of a number of communications devices wherein the signals comprising an audio stream and a video stream;
generating a first conference stream comprising the signals from each of the number of communications devices;
generating a second conference stream comprising the signals comprising the audio stream from each of the number of communications devices and signals comprising at least one but less than all video stream from the number of communication devices;
broadcasting, via the network, the first conference stream to a first subset of conference devices wherein the first subset of conference devices comprises at least one conference device; and
broadcasting, via the network, the second conference stream to a second subset of conference devices wherein the second subset of conference devices comprises at least one conference device.

10. The system of claim 9, wherein the first subset and the second subset are disjoint sets.

11. The system of claim 9, wherein at least one conference device, selected from the first subset of conference devices or the second subset of conference devices, and one of the number of communication devices are the same device.

12. The system of claim 9, wherein generating the second conference stream comprising signals comprising at least one but less than all video stream from the number of communication devices, further comprises generating the second conference stream comprising a replacement image for the video streams from the number of communication devices not included.

13. The system of claim 12, wherein the replacement image comprises a previously obtained still image.

14. The system of claim 12, wherein the replacement image comprises a previously obtained video image.

15. The system of claim 12, wherein the replacement image comprises an avatar image.

16. The system of claim 9, wherein the first conference stream and the second conference stream are each broadcast concurrently.

17. The system of claim 16, wherein broadcasting the first conference stream and the second conference stream comprises inserting a delay into the broadcasting of one of the first conference stream or the second conference stream to synchronize the first conference stream and the second conference stream together.

18. The system of claim 9, further comprising broadcasting one or more of the first conference stream or the second conference stream to a recording server.

19. A system, comprising:
means to receive, via the network, signals from each of a number of communications devices wherein the signals comprising an audio stream and a video stream;
means to generate a first conference stream comprising the signals from each of the number of communications devices;
means to generate a second conference stream comprising the signals comprising the audio stream from each of the number of communications devices and signals comprising at least one but less than all video stream from the number of communication devices;
means to broadcast, via the network, the first conference stream to a first subset of conference devices wherein the first subset of conference devices comprises at least one conference device; and
means to broadcast, via the network, the second conference stream to a second subset of conference devices wherein the second subset of conference devices comprises at least one conference device.

20. The system of claim 19, wherein excluding the video stream from the at least one of the number of communication devices comprises replacing the video stream with a replacement image.
